(19) United States
(12) Patent Application Publication
(10) Pub. No.: US 2008/0138169 A1
(43) Pub. Date: Jun. 12, 2008

(54) Fastener

(76) Inventors: Nicholas Jackson, Davisburg, MI (US); Nicholas O. Frederick, Sterling Heights, MI (US)

Correspondence Address: DICKINSON WRIGHT PLLC, 1901 L. STREET NW, SUITE 800, WASHINGTON, DC, 20036, US

(21) Appl. No.: 11/636,070

(22) Filed: Dec. 8, 2006

(51) Int. Cl. F16B 17/00

(52) U.S. Cl. 411/450

(57) ABSTRACT

A fastener assembly wherein the fastener is limited to one orientation for insertion into a receiving member. The fastener has a D-shape cross section defined by the outer extent of the fastener.

### FIELD OF THE INVENTION

The present invention is directed to a fastener assembly and, more particularly, a fastener having a geometry that limits the fastener to a single orientation relative to a member to which the fastener is coupled.

### BACKGROUND OF THE INVENTION

A wide range of fasteners exist for securing a first member to a second member. The first member is typically a base member such as a vehicle frame or body having an aperture for receiving the fastener. The second member may be any object capable of being secured to the base member, such as a door panel, electrical wiring, or hoses.

The fastener typically includes a head assembly useful in connection with securing two members together and in some cases for other purposes. For example, if a door panel is to be secured to the vehicle body, a flat head assembly may be used. To secure an elongated object such as electrical wiring to the base member, the head assembly may include a clip for retaining, routing, and wiring. A clip may also be configured to both assemble two members together while also retaining an elongated object such as wiring.

In assembling elongated wires to a base member or assembling two members together while also retaining an elongated member, problems may arise if the fastener becomes misaligned. Adjustment of the fastener may be needed before coupling the elongated member, such as wiring to the fastener. If the fastener remains misaligned and is not adjusted subsequent to insertion, excessive wear may occur to the member being retained by the fastener. However, when a fastener is adjusted subsequent to insertion, the fastener may become deformed, thereby reducing the ability of the fastener to stay retained to the base member. For example, by twisting the fastener within the aperture, certain retention features on the fastener may become deformed and as such have a reduced retention ability. Adjustments to the fastener, subsequent to insertion, may also deform a fastener and allow a retained fastener limited movement which in turn may cause squeaks or rattles between the retained member and the base member. Furthermore, such adjustments of the fastener require additional assembly steps and complicate the assembly process. Therefore, a fastener and fastener assembly that eliminates the need for adjustment of its alignment subsequent to installation in a base member is desirable.

### SUMMARY OF THE INVENTION

The present invention relates to a fastener assembly and, more particularly, a fastener having a geometry that limits the fastener to a single orientation relative to a base member to which the fastener is coupled.

The fastener includes a shank having a first side substantially free of fins and a second side opposing the first side. The second side includes a plurality of fins having an arcuate outer extent. The shank of the fastener may also include an arcuate shape on the second side. The third and fourth sides of the fastener are located between the first and second sides and may further include a plurality of fins. The shape of the fastener is generally a D-shape when viewed cross sectionally, perpendicular to the longitudinal length of the shaft and especially when viewing the outer extent of the fins and the first side cross sectionally. The fins on the third and fourth sides may be offset longitudinally from the arcuate fins. The shank of the fastener includes a rounded member with an elongated rectilinear member extending therefrom.

The fastener may also be part of a fastener assembly, where the fastener has a first side substantially free of fins and a second side having arcuate fins. The fastener has a cross sectional geometry that approximately matches the cross sectional geometry of a hole into which the fastener is inserted, to only allow the fastener to be inserted into the hole in a single orientation. The cross sectional shape of the fastener and hole is substantially D-shaped.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is an exploded perspective view of the fastener assembly including an exemplary head assembly;

FIG. 2 is a front elevational view of the fastener without a head assembly;

FIG. 3 is a rear perspective view of the fastener without a head assembly in phantom lines;

FIG. 4 is a partial cross sectional view of the fastener assembly in an assembled position; and

FIG. 5 is a top cross-sectional view taken along lines 5-5 in FIG. 4.

### DETAILED DESCRIPTION OF THE PREFERRED EMBODIMENT

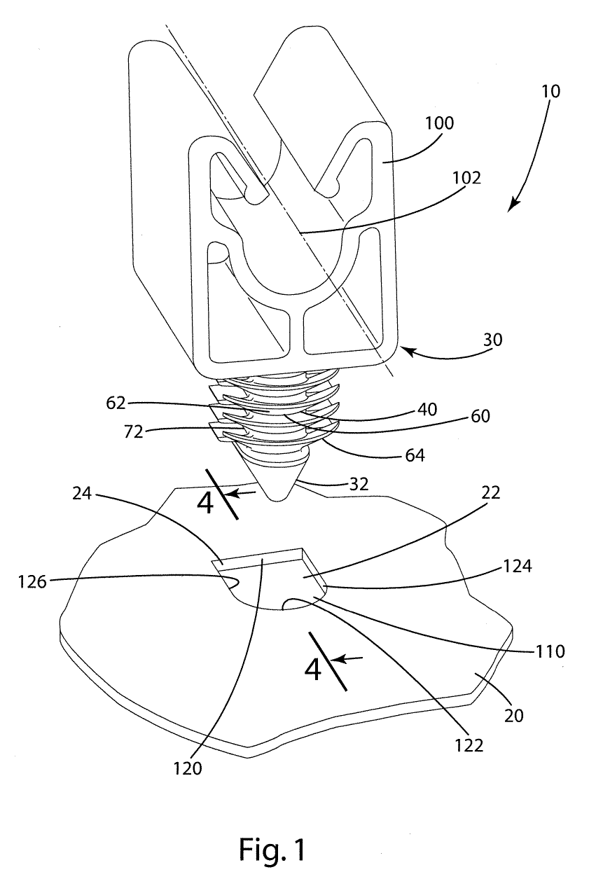

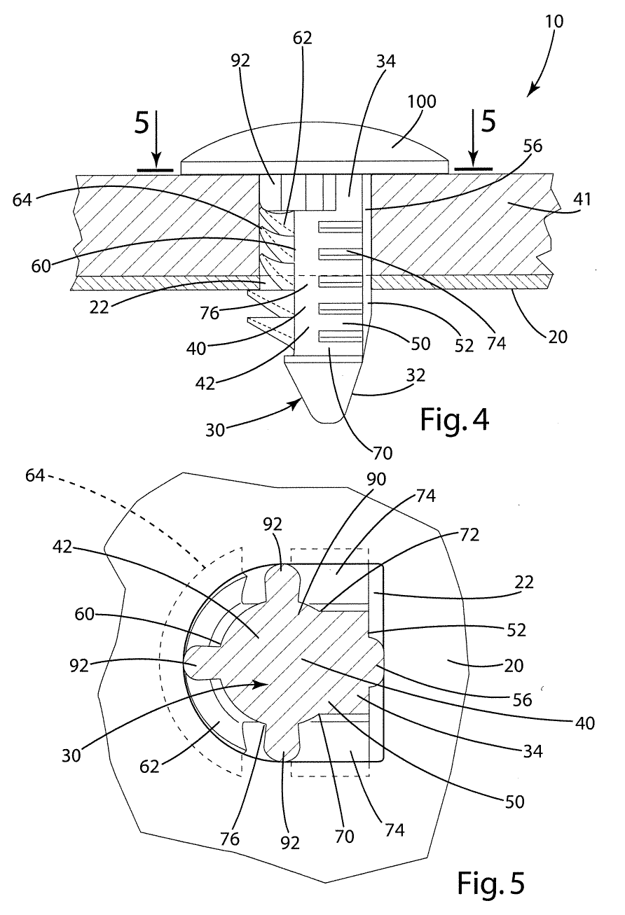

A fastener assembly 10 is illustrated in FIG. 1 including a member 20 to which a fastener 30 is secured. The fastener 30 may include a head assembly 100, such as the exemplary head assembly 100 shown in FIGS. 1 and 4. The head assembly 100 in FIG. 1 is configured to couple different components such as wires, hoses, cables, and any other desired items to the member 20.

As illustrated in FIG. 1, the member 20 defines an aperture 22. The member 20 may be any member to which it is desirable to attach another item. In the examples shown in FIGS. 1, 4, and 5, the member 20 is a steel panel such as a body panel of a vehicle. The exemplary aperture 22 includes an inner surface 24, having a first aperture side 120, a second aperture side 122 opposing the first aperture side 120, and third and fourth aperture sides 124, 126 between the first and second aperture sides 120, 122. In the examples, the aperture sides 120, 122, 124, and 126 collectively form a D-shaped aperture, with the first aperture side 120 forming the straight side of the D-shape, and the second, third, and fourth sides forming the arcuate portion of the D-shape.

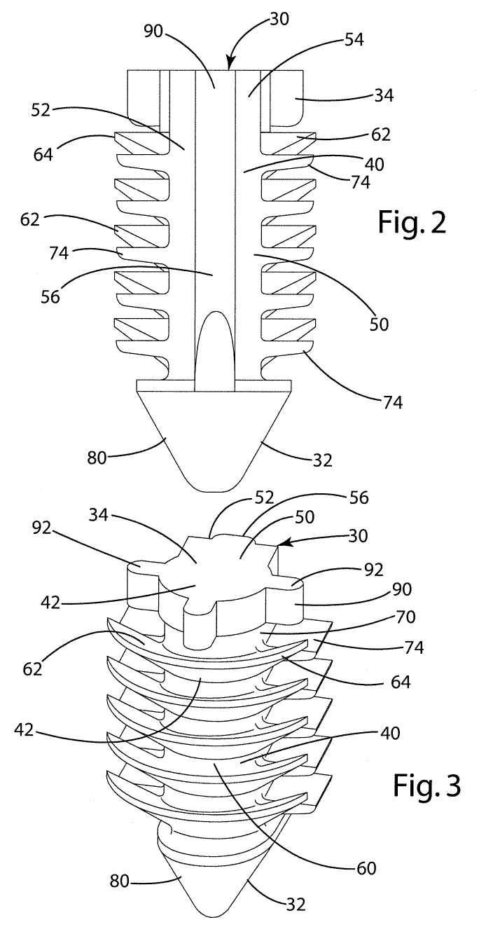

As shown in FIG. 2, the fastener 30 includes a shank 40 having a first end 32 and a second end 34 wherein the first end 32 is configured to be inserted into the aperture 22 (FIG. 4). The second end 34 of the shank 40 is configured to be held approximately within or near the aperture 22 upon full insertion of the shank 40 into the aperture 22. As illustrated in FIG. 5, the shank 40 is formed from a rounded portion 42 and a rectilinear member 50 extending therefrom in an elongated fashion along the length of the shank 40 (FIGS. 2 and 4), from approximately the first end 32 to the second end 34. The relative sizes of the rectilinear member 50 and the rounded portion 42 may vary as needed so long as the cross sectional shape of the fastener 30 forms a cross section approximately corresponding to the shape of the aperture 22, in this example, a D-shape.

As shown in FIGS. 2 and 3, the shank 40 further includes a first side 52 and a second side 60, opposing the first side 52. The shank 40 further includes third and fourth sides 70, 72 located between the first and second sides 52, 60. The first side 52 is located on the rectilinear member 50 and is illustrated as including a surface 54 substantially free of fins (FIG. 2). While the first side 52 is illustrated in FIGS. 2 and 4 as being substantially flat, but for an elongated nub 56, the first side 52 may vary somewhat in shape, provided the first side 52 along with the second, third and fourth sides 54, 56, and 58 maintain a “D” shape cross section. The “D” shape cross section is defined by the outer extent of the fins 62, 74 and the first side 52. The first side 52 may be formed without the elongated nub 56, however the elongated nub 56 is useful in providing an interference fit against the first aperture side 120 to assist the fins 62, 74 in retaining the fastener 30 within the aperture 22. The elongated nub 56 may be deformed against the aperture inner surface 24 to provide a greater retention of the fastener 30 within the member 20.

The second side 60 is located on the rounded portion 42 of the shank 40 and includes a plurality of arcuate fins 62 having an arcuate outer extent 64. In this example, the arcuate fins 62 are illustrated as having a semi-circular shape or a frusto-conical shape (FIG. 3) and an outer circumference that is greater than that of the overall size of the aperture 22.

The third and fourth sides 70, 72 include a plurality of rectangular fins 74 and an elongated gap 76. The rectangular fins 74 are illustrated in FIG. 2 as being offset along the longitudinal extent of the shank 40 from the arcuate fins 62, however, it should be appreciated that they may, in the alternative, be aligned. The rectangular fins 74 may also include other shapes, so long as the outer circumference of the fastener 30 is a D-shape and the outer circumference has a circumference greater than that of the overall size of the aperture 22. For example, the rectangular fins 74 may have an arcuate outer extent that further forms the desired D-shape of the shank 40. The third and fourth sides 70 and 72 are illustrated as including the sides of the rectilinear member 50 as well as a portion of the rounded portion 42. However, in some embodiments, the third and fourth sides may be bounded by the rectilinear member 50 only.

The shank 40 may further include on the first end 32 a tip 80 and on the second end 34 a head 90. The tip 80 may be formed in any desired shape to provide ease of insertion into the aperture 22 and is illustrated in a somewhat conical shape in FIG. 2. The head 90 may also take on a variety of configurations and one example, as best shown in FIGS. 3 and 5, is the head 90 having substantially the same cross-sectional shape as the shank 40 (FIG. 5) and including nubs 92 to aid in the interference fit between the fastener 30 and the inner surface 24 of the aperture 22.

As illustrated in FIGS. 1 and 4, the fastener 30 may include a head assembly 100. The head assembly 100 may take on any desired configuration to provide securing of an item to the member 20. For example, in FIG. 4, the head assembly 100 is illustrated as a somewhat enlarged planar member for securing a panel such as a door panel 41 to the member 20. As illustrated in FIG. 1, the head assembly 100 is a retaining clip, or variation thereof, for retaining cables, electrical wires, hoses, and other elongated members.

The aperture 22 in FIG. 1 has a D-shape 110 and includes the first aperture side, second aperture side, third aperture side, and fourth aperture side 120, 122, 124, and 126, respectively, that allow orientation of the fastener 30 in a single position due to the substantially similar D-shape of the fastener. More specifically, the D-shape does not permit rotation of the fastener 30 and as such, only one position is permitted. The D-shape permits a designer to specify a head assembly 100 orientation providing for ease of installation and preventing wear on the retained elongated objects such as electrical cables and hoses. Therefore, while in FIG. 1 the axis 102 of the exemplary head assembly 100 is shown as being aligned through the middle of the cross sectional “D” shape (the axis 102 passing through the middle of the first and second sides 52, 60), the axis 102 may be rotated in any desired direction. This allows maximization of the placement and orientation of the aperture 22 while also minimizing the wear on the retained member.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A fastener comprising at least two sides forming an outer extent, wherein said outer extent has a substantially D-shaped cross-section.

2. The fastener of claim 1 including a first side forming the substantially flat portion of the D-shaped cross-section.

3. The fastener of claim 2 including a second side opposing said first side, said second side forming the substantially arcuate portion of the D-shaped cross section.

4. The fastener of claim 3 further including opposing third and fourth sides, said third and fourth sides being located between said first and second sides.

5. The fastener of claim 3 wherein said second side includes a plurality of arcuate fins defining said arcuate portion.

6. The fastener of claim 5 further including a third side and a fourth side, at least one of said third and fourth sides including a plurality of substantially rectangular fins, said fastener having a longitudinal extent and wherein said rectangular fins are offset longitudinally from said arcuate fins along said longitudinal extent.

7. The fastener of claim 6 wherein said rectangular fins are spaced apart from said arcuate fins.

8. The fastener of claim 2 wherein said first side is substantially free of fins.

9. The fastener of claim 2 wherein said fastener has a longitudinal extent and said first side includes an elongated nub extending along said longitudinal extent.

10. The fastener of claim 1 including a substantially circular or elliptical shank having a rectilinear member extending therefrom.

11. The fastener of claim 10 wherein said fastener has a first side, second side, third side and a fourth side, and wherein said rectilinear member forms said first side and at least a portion of said third and fourth sides.

12. The fastener of claim 1 having a head having at least one nub extending therefrom.

13. A fastener comprising:
a shank having a first side and a second side opposing said first side, wherein said first and second sides have a substantially D-shaped cross-section, said first side forming the flat portion of the D-shaped cross section and said second side forming the arcuate portion of the D-shaped cross section.

14. The fastener of claim 13 wherein said first side is substantially free of fins, and said second side includes a plurality of fins having an arcuate outer extent.

15. The fastener of claim 14 wherein said first side includes an elongated nub extending along the length of said shank.

16. The fastener of claim 13 further including third side and a fourth side and wherein said third and fourth sides each include a plurality of rectangular fins.

17. The fastener of claim 16 wherein said first, second, third and fourth sides form a circumference having said D-shaped cross-section.

18. The fastener of claim 13 further including third side and a fourth side, and at least one of said third and fourth sides including a plurality of substantially rectangular fins, and wherein said second side includes a plurality of arcuate fins, said arcuate fins being offset from said rectangular fins.

19. The fastener of claim 13 wherein said shank is substantially circular with an elongated rectilinear member extending therefrom, said rectilinear member forming said first side.

20. The fastener of claim 13 further including a head formed on a first end of said shank and a lead portion formed on a second of said shank and wherein said head includes at least one nub extending therefrom.

21. A fastening assembly comprising a fastener having a first side and a second side including a plurality of arcuate fins, said fastener having a first cross sectional geometry; and
a member defining a hole having a second cross sectional geometry and wherein said first and second cross sectional geometries only allow said fastener to be inserted into said hole in a single orientation.

22. The fastening assembly of claim 21 wherein said first and second cross sectional geometries have a substantially D-shape.

23. The fastening assembly of claim 21 wherein said first side is substantially flat and said fastener further includes a plurality of substantially rectangular fins located between said arcuate fins and said first side.

24. The fastening assembly of claim 21 wherein said first and second cross sectional geometries prevent rotation of said fastener within said hole.
